(19) United States
(12) Patent Application Publication
(10) Pub. No.: US 2004/0149307 A1
(43) Pub. Date: Aug. 5, 2004

(54) Reversible self-cleaning window assemblies and methods of use thereof

(76) Inventor: Klaus Hartig, Avcoa, WI (US)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/735,295

(22) Filed: Dec. 11, 2003

Related U.S. Application Data
(60) Provisional application No. 60/434,484, filed on Dec. 18, 2002.

(51) Int. Cl. B32B 17/06

(52) U.S. Cl. 134/1; 428/432

(57) ABSTRACT

The present invention relates to self-cleaning reversible window assemblies comprising one or more photocatalytic layers deposited on two generally opposed major surfaces of a transparent substrate. When the major surfaces are exposed to ultraviolet radiation, such as that present in sunlight, the photocatalytic layers chemically degrade organic contaminants deposited on the surfaces of the substrate. The self-cleaning reversible window assemblies of the present invention are reversible thereby allowing for either of the opposed major surfaces to be exposed to ultraviolet radiation from sunlight.

### FIELD OF THE INVENTION

The present invention relates to reversible window assemblies which include features that provide self cleaning characteristics. More particularly, the present invention provides a reversible window assembly wherein one or more photocatalytic coatings are applied to opposed surfaces of a transparent substrate.

### BACKGROUND OF THE INVENTION

There is an increasing search to functionalize glazings on glass substrates by depositing at the surface thereof thin layers intended to confer a specific property according to the targeted application. One problem a functional coating is intended to remedy is the reduction or prevention of window soiling. Keeping windows and other glass surfaces clean is a relatively expensive and time-consuming process. While cleaning any individual window is not terribly troublesome, keeping a larger number of windows clean can be a significant burden. For example, with modern glass towers, it takes significant time and expense to have window washers regularly clean the exterior and interior surfaces of the windows.

Windows and other transparent substrates can become “dirty” or “soiled” in a variety of ways. Two of the primary manners in which windows can collect dirt involve the action of water on the glass surface. First, the water itself can deposit dirt on the surface of a window. Obviously, dirty water landing on a window will leave residue on the window upon drying. Even if relatively clean water lands on a window, each water droplet will tend to include and/or collect dust and other airborne particles. These particles, and any other chemicals that become dissolved in the water, will become more concentrated over time. The result is a characteristic spot (i.e. a drying ring) on the glass surface.

The second way in which water tends to give a window or other glass surface a soiled or less attractive appearance is tied to an attack on the glass surface itself. As a droplet of even relatively clean water sits on a glass surface, it will begin to leach alkaline components from the glass. For typical soda lime glass, the soda and lime will be leached out of the glass, increasing the pH of the droplet. As the pH increases, the attack on the glass surface will become more aggressive. As a result, the glass that underlies a drying water droplet will become somewhat rough by the time the water droplet has completely dried. In addition, the alkaline components that were leached out of the glass will be re-deposited on the glass surface as a drying ring. Not only does this dried alkaline material detract from the appearance of the glass, it also has a tendency to form a solution when the glass surface is wetted again. Thus, water droplets that subsequently coalesce on the glass surface will tend to have a high pH as soon as they are formed.

Additionally, transparent substrates regularly accumulate foreign matter due simply to use. The touching of the transparent substrate by humans, birds, animals, plants or any other living species can leave marks, such as organic residue on the surface. Therefore, in order to maintain a clear surface and preserve the overall appearance and integrity of the transparent substrate, some action to clean the substrate must be taken.

It is understood that “self-cleaning” glazings or coatings on transparent substrates, like windows, can maintain over time the appearance and surface properties of the substrate. In particular, such glazings or coatings require less frequent cleaning and/or improve the visibility of the substrate by removing dirt or soiling material which is gradually deposited at the surface of the substrate over time.

Various products have been developed to enable a self-cleaning substrate. One such product currently being investigated includes the application of self-cleaning photocatalytic coatings to a substrate. Research in this area is founded on the ability of certain coatings, such as metal oxides, to absorb ultraviolet radiation and photocatalytically break down organic materials such as oil, plant matter, fats, greases and other organic matter deposited on the surface of the substrate. The most powerful of these photocatalytic metal oxides appears to be titanium dioxide (titania). However, other metal oxides also appear to possess photocatalytic properties. Examples of photocatalytic coatings include, but are not limited to, oxides of titanium, iron, silver, copper, tungsten, aluminum, zinc, strontium, palladium, gold, platinum, nickel, and cobalt. In addition to being photocatalytic, titanium dioxide is hydrophilic which makes possible complete wetting of the substrate surface when water condensation or rain is deposited on the coating. The hydrophlicity is quickly lost when the ultraviolet radiation stops, but it can be fully recovered after re-exposure to ultraviolet radiation.

Generally, photocatalytic reactions occur by the irradiation of light on semiconductors. For example, when light contacts the surface of a transparent substrate that is coated with a photocatalytic coating, the photon energy at the surface of the substrate increases. When the photon energy is greater than or equal to the band gap energy of the photocatalytic coating, an electron (e−) is promoted from the valence band into the conduction band, leaving a void. Some of the excited electrons in the conduction band and some of the voids in the valence band recombine and dissipate the input energy as heat. However, a number of voids can diffuse to the surface of the titanium dioxide and react with molecules absorbed on the surface to form radicals, such as —OH radicals, which can decompose organic compounds existing on the surface into CO₂ and H₂O. Moreover, to the extent that the residue may survive this photocatalysis, such residue may be more easily removed by washing or, for outdoor applications, by run-off water, such as rainwater.

Various light sources, such as fluorescent lamps or sunlight, are capable of emitting light having a higher energy than the band gap energy of a photocatalyst. The photoexcitation wavelength for a photocatalyst such as titania is in the ultraviolet region. In this instance, when the titania-containing coating is exposed to the sunlight, it can be advantageously photoexcited by ultraviolet light contained in the sunlight.

The utilization of coatings on transparent substrates for insulation or antireflection purposes has been disclosed in previously issued patents. For example, in U.S. Pat. No. 4,235,048, Gillery discloses the use of coated glass articles in a reversible window unit for insulation purposes. More particularly, the coated glass surfaces are used to reflect or absorb incident solar energy depending upon how the coated surface is oriented.

Additionally, photocatalytic coatings have been utilized and disclosed in art for preserving and cleaning the outside surface of a substrate in U.S. Pat. No. 6,090,489 (Hayakawa et. al.) and U.S. Pat. No. 6,103,363 (Boire et. al). This provides the benefit of a self-cleaning outside surface, but does nothing to clean the self-clean the inside surface.

It would be advantageous to provide a reversible window unit with photocatalytic coatings on each side of the glass surface for self-cleaning purposes that can be activated or reactivated, depending on the orientation of the window unit, by exposure to the ultraviolet radiation in the sunlight.

### SUMMARY OF THE INVENTION

The present invention involves a reversible self-cleaning window assembly comprising a transparent substrate coated with one or more photocatalytic layers and a reversible framing assembly. The photocatalytic coatings chemically degrade organic material deposited on the surface of the substrate to a point wherein the organic material disappears or is readily washed away. The photocatalytic layers may include, but are not limited to, oxides comprised of such metals as titanium, iron, silver, copper, tungsten, aluminum, zinc, strontium, palladium, gold, platinum, nickel, and cobalt. The coated transparent substrate is useful as a window and can be self-cleaned by facing the photocatalytic layer toward the sun. Therefore, the reversible self-cleaning window assembly is most useful as a window unit which is reversible so that the major surfaces of the substrate, coated by the photocatalytic layer, may be alternately self-cleaned depending upon which major surface is exposed to the ultraviolet radiation in the sunlight.

### BRIEF DESCRIPTION OF THE DRAWINGS

FIG. 1 is a schematic cross-sectional view of a transparent substrate containing a coating in accordance with the invention;

FIG. 2 is a schematic cross-sectional view of a multi-pane insulated transparent substrate unit containing a coating in accordance with the invention;

FIG. 3 is a schematic of a reversible window assembly set on a pivot bearing a coating in accordance with the invention;

FIG. 4 is a schematic of a reversible window assembly having a vertical swing reversing mechanism without any inward projection of the window during reversal;

FIG. 5 is a schematic of a reversible self-cleaning window assembly having a horizontal swing reversing mechanism without any inward projection of the window during reversal;

FIG. 6 is a schematic of a reversible window assembly wherein the window may be completely removed from the outer frame for reversal.

### DETAILED DESCRIPTION OF THE PREFERRED EMBODIMENTS

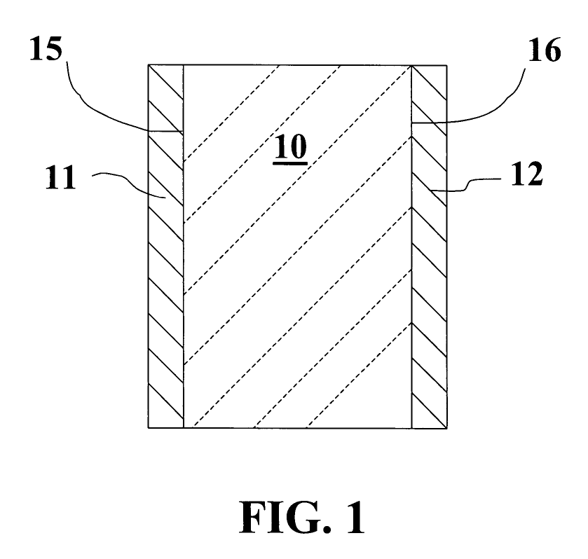

In the present invention, the reversible self-cleaning window assemblies normally comprise a transparent substrate, coated with photocatalytic material, which is retained by a reversible framing assembly. Generally, the transparent material, preferably glass, plexiglass or the like, is usually in the planer form of a film or sheet. FIG. 1 schematically illustrates a transparent substrate bearing a coating in accordance with one useful embodiment of the present invention. In the illustrated embodiment, the transparent substrate 10 comprises glass, such as soda-lime-silica glass, with major constituents including but not limited to, SiO₂, Na₂O, CaO, MgO, K₂O and Al₂O₃.

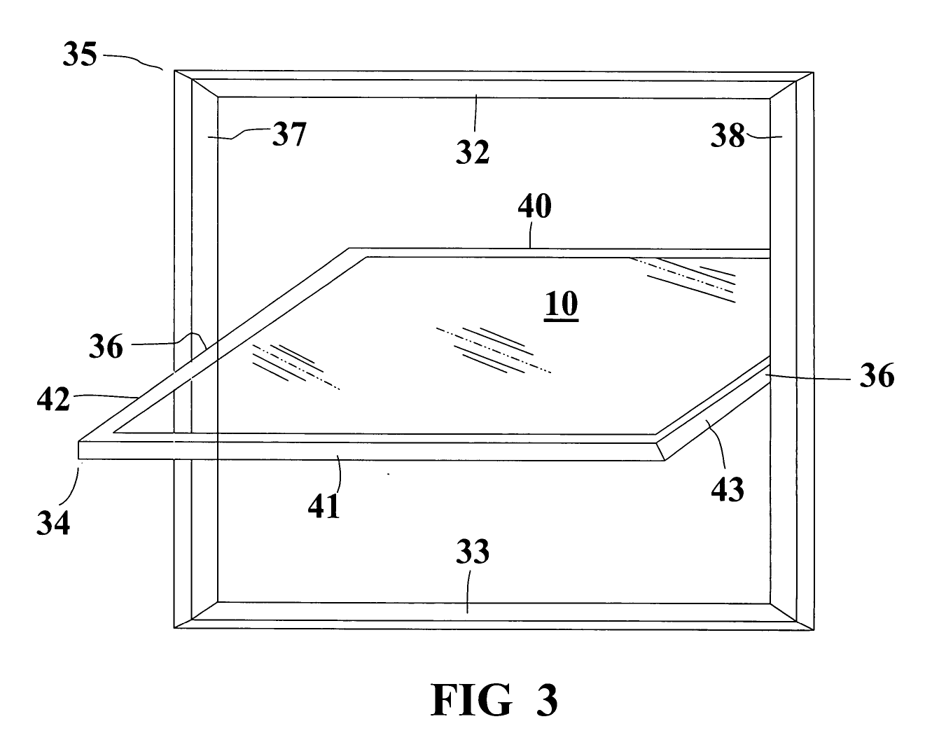

The transparent substrate 10 depicted in FIG. 1 includes opposing major surfaces 15 and 16. For ease of discussion, first major surface 15 will be designated exterior face and second major surface 16 will be designated interior face. (The designation of “interior” and “exterior” face in the ensuing discussion is somewhat arbitrary. It is assumed, though, that in most circumstances the exterior face will be exposed to an ambient environment outside a building wherein it may come into contact with dirt, water, and the like. The interior face may also be oriented toward the same kind of ambient environment only inside a building. In the embodiments illustrated in FIGS. 3-6, this interior face is oriented towards a low UV environment). Exterior face 15 is coated with photocatalytic layer 11. Similarly, interior face 16 is coated with photocatalytic layer 12. The photocatalytic layers 11 and 12 may be comprised of any photocatalytic material or materials, such as an oxide of a metal selected from the group consisting of titanium, iron, silver, copper, tungsten, aluminum, zinc, strontium, palladium, gold, platinum, nickel, cobalt and any combination thereof. One embodiment of a suitable photocatalytic coating comprises an inorganic titanium compound, such as an oxide of titanium.

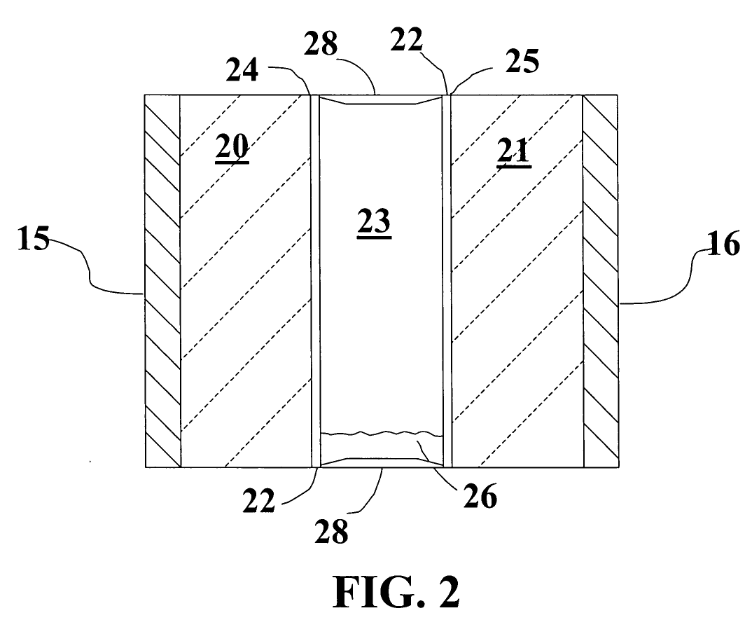

It is noted that the substrate 10 of the present application may also be comprised of a double paned insulated glass unit, wherein the exterior surface 15 is located on a first substrate and exposed to the ambient atmosphere outside a building and the interior face 16 is located on a second substrate and exposed to the ambient atmosphere inside a building. See FIG. 2 for an illustration of one embodiment of an insulated glass unit.

Generally, an insulated unit is comprised of two or more transparent substrate panels separated by a sealed dry air space, and a means of precisely separating the substrate panels, such as spacers. FIG. 2 is a schematic illustration of a multi-pane insulated unit in accordance with an embodiment of the invention. Such an insulated unit would generally comprise two panes of transparent substrates, 20 and 21, held in a spaced-apart relationship by a spacer 22 thereby creating an interpane space 23. In this embodiment, the photocatalytic coating is deposited on the exterior face of transparent substrate 20 oriented away from transparent substrate 21 as well as on the interior face of transparent substrate 21 oriented away from transparent substrate 20. That is, both coatings, interior and exterior, should be oriented away from the opposing transparent substrate pane. The spacer 22 is bonded on one side to the interior surface 24 of transparent substrate 20 and to the interior surface 25 of transparent substrate 21. Typically, the spacer 22 will be formed of metal, such as stainless steel or the like and will have a desiccant 26 retained therein. This desiccant will be allowed to communicate with a gas, such as argon, in the interpane space 23 to remove any moisture which may seep between the panes of glass. An exterior seal 28 may be carried around the external periphery of the spacer 22 to form a reliable gas and moisture barrier.

A variety of photocatalytic coatings can be formed on the transparent substrate using a variety of deposition processes, such as magnetron sputtering, pyrolytic coating and any other coating process known in the art. For example, useful photocatalytic coatings are described in U.S. Pat. No. 5,874,701 (Watanabe et al), U.S. Pat. No. 5,853,866 (Watanabe et al), U.S. Pat. No. 5,961,843 (Hayakawa et al.), U.S. Pat. No. 6,139,803 (Watanabe et al), U.S. Pat. No. 6,191,062 (Hayakawa et al.), U.S. Pat. No. 5,939,194 (Hashimoto et al.), U.S. Pat. No. 6,013,372 (Hayakawa et al.), U.S. Pat. No. 6,090,489 (Hayakawa et al.), U.S. Pat. No. 6,210,779 (Watanabe et al), U.S. Pat. No. 6,165,256 (Hayakawa et al.), U.S. Pat. No. 5,616,532 (Heller et al.), U.S. Pat. Nos. 5,849,200, 5,849,200 (Hayakawa et al.), and U.S. Pat. Nos. 5,845,169, 5,849,200 (Hayakawa et al.), the entire contents of each of which are incorporated herein by reference.

In a particularly advantageous embodiment, the photocatalytic coating comprises a sputtered film of titanium oxide. The titanium oxide can be sputter deposited in several ways. First, targets formed of metallic titanium can be sputtered in oxidizing atmospheres thereby creating a layer of an oxide of titanium on the substrate's surface. Second, targets formed of titanium dioxide can be sputtered in inert atmospheres. Examples of useful magnetron sputtering techniques and equipment are also disclosed in United States patents, such as U.S. Pat. No. 4,166,018, issued to Chapin, the entire teachings of which are incorporated herein by reference.

In one embodiment of the present invention, a titanium dioxide coating may be deposited on a substrate by sputtering substoichiometric titanium oxide targets. These targets are especially preferred since they have high electrical conductivity, allowing them to be sputtered at high rates. Targets of this nature are described in U.S. Pat. No. 6,461,686, the entire contents of which is incorporated herein by reference. Targets of this nature are available from well known commercial suppliers, such as Bekaert VDS nv, which is located in Deinze, Belgium. Thus, in this embodiment, the oxide of titanium film is deposited by positioning a substrate beneath one or more substoichiometric titanium oxide targets. The targets are then sputtered, most preferably in a sputtering atmosphere comprising argon, oxygen, or a mixture of argon and oxygen. Suitable mixtures include, but are not limited to, 70-90% argon by volume and 10-30% oxygen by volume. The use of substoichiometric titanium oxide targets is also described in U.S. Pat. No. 6,461,686.

The photocatalytic coating may be applied or added to additional coatings or coating stacks that are in turn applied to the transparent substrate in order to provide antireflective, absorptive or insulating properties. For example, the photocatalytic coating may be added to a coating stack including a reflective layer comprising a metal such as silver, and an absorptive layer comprising a semiconducting material such as silicon dioxide. The photocatalytic coating may also be applied to self-clean an insulated glass unit, such as an insulated glass unit designed to conserve energy.

As previously suggested the application of one or more photocatalytic coatings may be in addition to other coating stacks administered to one or both of the substrates of the insulated glass unit. For example, a photocatalytic coating may be applied to an insulated glass unit in addition to one or more coating stacks having insulative or reflective characteristics such as low emissivity coatings, high transmittance coatings, solar coatings, tinted coatings and the like.

Additionally, the reversible window assembly of the present invention includes a reversible frame assembly. FIG. 3 depicts one embodiment of a reversible frame assembly of the present invention that comprises a window sash 34 adjoined to an outer frame 35 by one or more pivoting devices 36. Such an assembly is commercially available from Weatherseal, Weatherseal Holdings Ltd, Weatherseal House, The Phoenix Centre, Road 1, Winsford Industrial Estate, Winsford, Cheshire CW7 3PZ.

As depicted in FIG. 3, the outer frame 35 includes an upper jamb 32 and a lower sill 33 at the top and bottom thereof and a pair of side jambs 37, 38 secured at their ends to upperjamb 32 and lower sill 33. The outer frame 35 may be made of materials including, but not limited to, wood, vinyl, plastic, metal, fiberglass or any other suitable material which allows the outer frame 35 to be mounted in a building opening (not shown).

The window sash 34 positions and retains the transparent substrate 10 by extending around and embracing the periphery of the transparent substrate 10. The window sash 34 generally includes a pair of upper and lower horizontal members 40, 41 and a pair of vertical members 42, 43 coupled at their ends to the horizontal members 40, 41. The window sash 34 may be made of such materials, as described above for outer frame 35, and that are suitable to retain the transparent substrate 10.

Additionally, the embodiment depicted in FIG. 3 is a reversible self cleaning window assembly wherein the pivoting device 36 is one or more pivot pins that are centrally secured to the outer frame 35, either between side jambs 37, 38 (as shown) or between the upper jamb 32 and lower sill 33. The pivot pins may be comprised of any suitable means for securing and pivoting the window sash 34 and substrate 10, such as rivots, screws, bolts or the like. As previously suggested, the pivot device 36 generally adjoins the outer frame 35 to the vertical members 42, 43 or the horizontal members 40, 41 of the window sash 34, as described above, to allow the transparent substrate 10 enclosed within window sash 34 to be rotated. As depicted in FIG. 3, pivot pins 36 adjoin the outer frame 35 to the window sash 34 centrally at the vertical members 42, 43.

In operation, the transparent substrate 10 incorporated within the embodiment of the reversible self-cleaning window assemblies depicted in FIG. 3 may be set with either its interior face or exterior face facing outwards. Upon the accumulation of soil-like material, such as organic matter, on the interior face of the substrate or insulated glass unit, the transparent substrate 10 may be rotated 180 degrees upon the pivot device 36 to reverse the face of the transparent substrate 10, thereby exposing the dirty surface to the higher concentration of UV light, such as sunlight, outside. The rotation of the window sash 34 can be initiated by unlocking window sash 34 from outer frame 35 and applying a gentle force to the top or bottom of the window sash 34 causing it to swing outwards. Once the transparent substrate 10 is rotated to the desired orientation, window sash 34 is again locked to outer frame 35 to prevent transparent substrate 10 from further rotation. To rotate transparent substrate 10 back to its original orientation, window sash 34 is unlocked from outer frame 35, a gentle force is applied to the top or bottom of window sash 34 causing it to swing outwards and allowing it to rotate back to its original position. Additionally, as will be obvious to one skilled in the art, other pivot mechanisms for reversing a window may be used. In this as well as other reversible window configurations, the transparent substrate 10 includes photocatalytic coatings on both its interior face and exterior face for self-cleaning purposes.

The photocatalytic coated transparent substrate may also be rotated in a reversible frame assembly as described in U.S. Pat. No. 4,616,443 (Araki et. al.), which is hereby incorporated by reference herein. This type of reversible frame assembly has a top swing reversing mechanism configured to prevent inward projection of the window during reversal. Top swing reversible frame assemblies are commercially available from Kawneer UK Ltd, Kawneer UK Ltd, Astmoor Road, Astmoor Ind Est, Runcom WA7 1QQ UK. as well as BlindCraft Edinburgh, BlindCraft Edinburgh 2 Peffer Place, Edinburgh EH16 4BB UK.

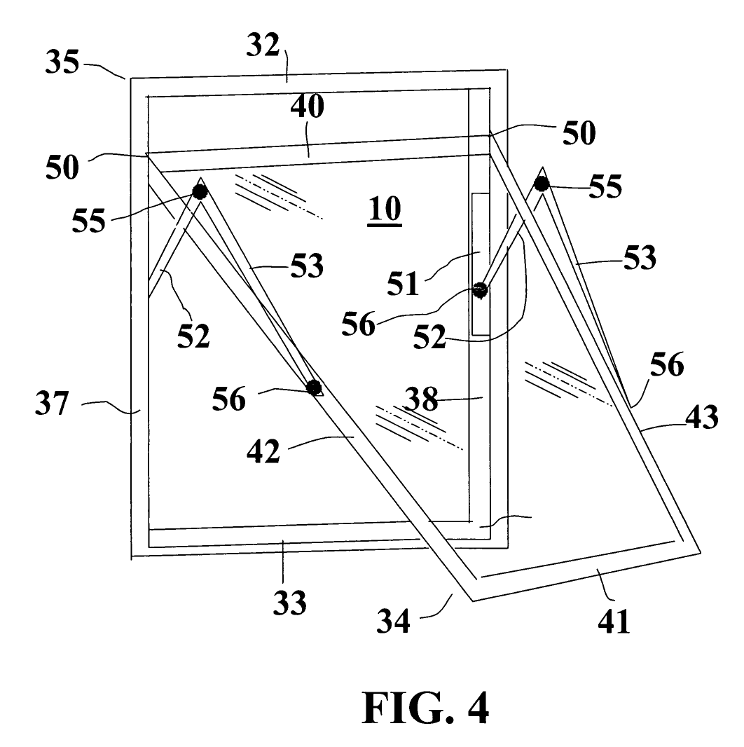

As depicted in FIG. 4, an embodiment of the reversible self-cleaning window assemblies includes a reversible frame assembly with a pivoting device 36 in the form of a top swing mechanism. The reversible frame assembly with the top swing mechanism comprises a window sash 34 that embraces and retains the photocatalyticly coated transparent substrate 10, and is adjoined to an outer frame 35. The top swing mechanism includes guide rollers 50 attached to opposite sides of a horizontal member 40 of the window sash 34 and are inserted in concave grooves provided in side jambs 37, 38 of outer frame 35. The concave grooves extend the length of side jambs 37, 38 to allow guide rollers 50 to move in an up and down direction.

To each of the side jambs 37, 38 of outer frame 35 is attached a link assembly. Generally, the link assemblies utilized in this embodiment of the present invention comprise a fixed linked member 51 attached to side jambs 37, 38 through suitable means such as rivets or screws, and first movable link member 52 pivotably connected to the fixed link member 51 by a pivot pin 56. Next, a second moveable link member 53 is hingedly connected to first moveable link member 52 and to window sash 34 at vertical side members 42, 43 by pivot pins 55, 56.

Upon the determination of a dirty interior face of the transparent substrate 10, the reversible self cleaning window assembly depicted in FIG. 4, is reversed by pushing outwardly the lower end of window sash 34 toward the outdoor direction. The guide rollers 50 move downwards inside concave grooves (not shown) allowing the window sash 34 and photocatalyticly coated transparent substrate 10 to rotate 180 degrees through pivot pins 55, 56. To rotate transparent substrate 10 back to its original orientation, the upper portion of window sash 34 is pushed outwards in the outdoor direction allowing the guide rollers 50 to move from the bottom towards the top inside the concave grooves, thereby allowing the window sash 34 to rotate inwardly at the pivot pins 55, 56. Again, the transparent substrate 10 generally has photocatalytic coating on both its interior and exterior faces to provide the self cleaning charactistics to both sides of the substrate 10.

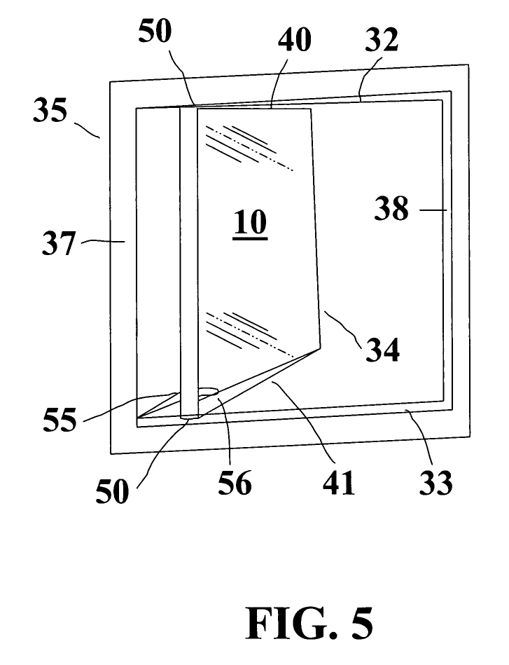

FIG. 5. depicts an alternate embodiment of FIG. 4 wherein window sash 34 enclosing transparent substrate 10 is rotated horizontally, instead of vertically. In FIG. 5 the pivoting device 36 includes guide rollers 50 that are placed on the upper and lower members 40 and 41 of window sash 34. Concave grooves (not shown) are provided in upper jamb 32 and lower sill 33 and extend substantially the entire length thereof. To rotate window sash 34 and transparent substrate 10, window sash 34 is first disengaged from outer frame 35 and a gentle force is applied to the right side of window sash 34 causing it to swing outwards. Guide rollers 50 then move across the concave grooves towards the side jamb 38 and window sash 34 rotates 180 degrees through pivot pins 55, 56 attached to a linkage assembly as described above. The linkage assembly in this embodiment originates from upper jamb 32 and lower sill 33. To rotate window sash 34 back to the original orientation, force is applied to the left side of window sash 34 causing it to swing outwards and guide rollers 50 to move back across outer frame 35 and to their original position at side jamb 37.

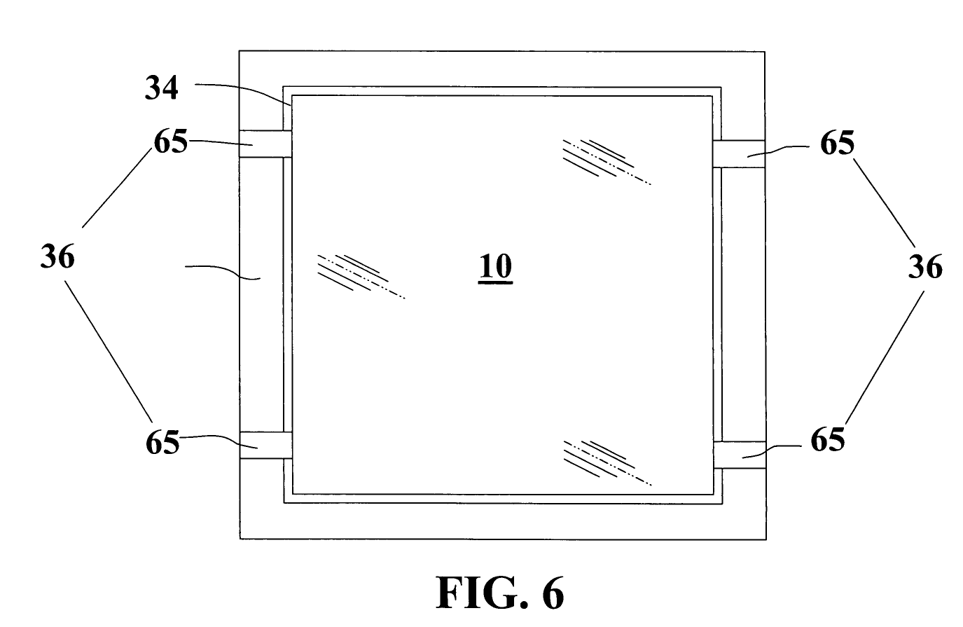

FIG.6 depicts another alternate embodiment of a reversible window assembly containing no attachable pivoting mechanism, for attaching the window sash 34 to the outer frame 35. However, the pivoting device 36 of the embodiment illustrated in FIG. 6 is a plurality of reversible brackets 65 that position and retain the substrate in place regardless of which surface faces the outside environment. In this type of reversible window assembly, the window sash 34, which embraces the transparent substrate 10, is manually placed in outer frame 35 and locked into place with the brackets 65. The brackets 65 may include any type of hooking and locking mechanisms known in the art. To reverse the window sash 34 and the photocatalyticly coated transparent substrate 10, brackets 65 are unlocked and the window sash 34 and substrate 10 are pulled from the outer frame 35. The window sash 34 and substrate 10 are next manually rotated 180 degrees and placed back in outer frame 35. The brackets 65 are then locked so as to secure the sash 34 and substrate 10 in the rotated position. Similar to the previously described embodiments, photocatalytic coatings can again be applied to both the interior and exterior faces of transparent substrate 10 in order to provide the desired self-cleaning properties.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A reversible self-cleaning window assembly comprising:
a) a reversible frame assembly including a window sash adjoined to an outer frame by one or more pivoting devices; and
b) a substrate retained by the window sash including an exterior face and an interior face, wherein one or more photocatalytic layers are applied to the exterior face and interior face.

2. The reversible self-cleaning window assembly according to claim 1, wherein the substrate is a glass pane.

3. The reversible self-cleaning window assembly according to claim 1, wherein the substrate is an insulated glass unit.

4. The reversible self-cleaning window assembly according to claim 1, wherein the photocatalytic layer comprises an oxide of a metal selected from the group consisting of titanium, iron, silver, copper, tungsten, aluminum, zinc, strontium, palladium, gold, platinum, nickel, and cobalt.

5. The reversible self-cleaning window assembly according to claim 4, wherein said metal oxide comprises titania.

6. A reversible self-cleaning window assembly comprising:
a) a transparent substrate having generally opposed first and second faces, each face bearing a functional coating, the said functional coating comprising a photocatalytic material adapted to chemically degrade organic contaminant that accumulates on the first or second face of said substrate when exposed to ultraviolet radiation; and
b) an outer frame operably adjoined to a sash, said sash supporting the substrate, and wherein the outer frame and sash are configured to allow the substrate to be selectively oriented in a primary orientation or secondary orientation, the primary orientation characterized in that said first face is exposed to a high ultraviolet radiation environment and said second face is exposed to a low ultraviolet radiation environment, the secondary orientation characterized in that said second face is exposed to said high ultraviolet radiation environment while said first face is exposed to said low ultraviolet radiation environment.

7. The reversible self-cleaning window assembly according to claim 6, wherein the transparent substrate is glass.

8. The reversible self-cleaning window assembly according to claim 6, wherein the transparent substrate is an insulated glass unit.

9. The reversible self-cleaning window assembly according to claim 6, wherein the sash is configured such that when the transparent substrate is secured in the outer frame, it can be removed and resecured in either the primary or the secondary orientation.

10. The reversible self-cleaning window assembly according to claim 6, wherein the window assembly includes a pivot device about which the transparent substrate can be rotated between the primary and secondary orientation.

11. The reversible self-cleaning window assembly according to claim 6, wherein the photocatalytic material comprises sputtered material.

12. The reversible self-cleaning window assembly according to claim 11, wherein the photocatalytic layer comprises sputtered material having a substantially uniform thickness over the first face and second face of the substrate.

13. The reversible self-cleaning window assembly according to claim 6, wherein said photocatalytic material comprises an oxide of a metal selected from the group consisting of titanium, iron, silver, copper, tungsten, aluminum, zinc, strontium, palladium, gold, platinum, nickel, and cobalt.

14. The reversible self-cleaning window assembly according to claim 13, wherein said metal oxide comprises titania.

15. A method of reducing transparent substrate surface contamination, the method comprising the steps of:
a) providing a transparent substrate having generally opposed first and second major surfaces, each major surface containing a functional coating, the said functional coating comprising a photocatalytic material adapted to chemically degrade organic contaminants;
b) positioning the transparent substrate in a primary orientation wherein said first major surface is exposed to a high ultraviolet radiation environment while said second major surface is exposed to a low ultraviolet radiation environment; and
c) reversing the orientation of the transparent substrate once organic material has accumulated on the second major surface by positioning the window in a secondary orientation wherein said second major surface is exposed to said high radiation environment while said first major surface is exposed to said low radiation environment, thereby activating the photocatalytic material on said second major surface to chemically degrade said accumulated organic material.

16. The method of reducing transparent substrate surface contamination according to claim 15, wherein the transparent substrate is glass.

17. The method of reducing transparent substrate surface contamination according to claim 15, wherein the transparent substrate is an insulated glass unit.

18. The method of reducing transparent substrate surface contamination according to claim 15, wherein the substrate is included in a window assembly that has a pivot device about which the substrate can be rotated between the primary and secondary orientations.

19. The method of reducing transparent substrate surface contamination according to claim 15, wherein the photocatalytic material comprises sputtered material.

20. The method of reducing transparent substrate surface contamination according to claim 19, wherein the photocatalytic material comprises sputtered material having a substantially uniform thickness over the first face and second face of the substrate.

21. The method of reducing transparent substrate surface contamination according to claim 15, wherein said photocatalytic material comprises an oxide of a metal selected from the group consisting of titanium, iron, silver, copper, tungsten, aluminum, zinc, strontium, palladium, gold, platinum, nickel, and cobalt.

22. The reversible self-cleaning window assembly according to claim 21, wherein said metal oxide comprises titania.
